(19) United States
(12) Patent Application Publication
(10) Pub. No.: US 2008/0107817 A1
(43) Pub. Date: May 8, 2008

(54) Coating Composition

(76) Inventors: Fergus Rupert Fitzgerald, County Dublin (IE); Eamonn Martin Blair, Dublin (IE)

Correspondence Address: JACOBSON HOLMAN PLLC, 400 SEVENTH STREET N.W., SUITE 600, WASHINGTON, DC, 20004, US

(21) Appl. No.: 11/659,074

(22) PCT Filed: Oct. 18, 2005
(86) PCT No.: PCT/IE05/00115

§ 371 Date: Feb. 1, 2007

Related U.S. Application Data
(60) Provisional application No. 60/618,977, filed on Oct. 18, 2004.

(51) Int. Cl. C09D 5/02; C08K 3/26; C04B 41/63; C04B 14/28; C09D 5/34

(52) U.S. Cl. 427/428.01; 106/287.24; 106/15.05

(57) ABSTRACT

A coating composition for in-situ coating of a surface comprises calcium carbonate, an acrylic or vinylacetate-based binder, a thickening agent, and a rheology modifier, the weight ratio of the calcium carbonate to acrylic-based binder being from 5:1 to 15:1. The coating may be applied directly to a plasterboard wall or ceiling using a roller technique and provides a high quality surface finish to which a paint may be applied directly.

The invention relates to a coating composition for in situ coating a surface, especially a wall formed by plasterboard wall panels to provide a high quality surface finish.

Plasterboard which is referred to in some countries as wallboard, gypsum wallboard, or drywall is widely used to provide internal walls and/or ceilings in building constructions. The plasterboard is cut to a desired size from large panels and the cut lengths are attached to fixtures such as wall bates. The joints between adjacent boards are filled and the surface of the wall is skimmed with a plaster compound by manual towelling. This is extremely time consuming, labour intensive, and requires considerable skill. In addition, even with such skilled finishing techniques joints and fixing points are often clearly visible through the skin. This is a particular problem when the wall is painted as the painting tends to highlight rather than hide such imperfections.

There is therefore a need for a coating system for coating a surface, especially an erected plasterboard wall or ceiling which will eliminate or at least substantially reduce the problems with known systems.

### STATEMENTS OF INVENTION

According to the invention there is provided a coating composition for in-situ coating of a surface comprising calcium carbonate, an acrylic or vinylacetate-based binder, a thickening agent, and a rheology modifier, the weight ratio of the calcium carbonate to binder being from 5:1 to 15:1

In one embodiment the weight ratio of calcium carbonate to binder is from 7:1 to 14:1.

The weight ratio of the calcium carbonate to binder may be approximately 10:1.

In one embodiment the calcium carbonate is present in an amount of from 65 to 80% by weight of the composition. The calcium carbonate may be present in an amount of approximately 70% by weight of the composition.

In one embodiment the binder is present in an amount of from 5 to 10% by weight of the composition. The binder may be present in an amount of approximately 6.5% by weight of the composition.

In one embodiment the binder is a styrene acrylic binder or an acrylic binder.

In one embodiment the thickening agent comprises a cellulose thickener. The cellulose thickener may be present in any amount of from 0.1% to 0.5% by weight of the composition. The cellulose thickener may be present in an amount of from 0.2% to 0.4% by weight of the composition. More particularly, the cellulose thickener may be present in an amount of from 0.25% to 0.35% by weight of the composition.

In one embodiment of the invention the rheology modifier comprises a synthetic clay. The rheology modifier may comprise a synthetic silicate. More particularly the rheology modifier is laponite.

In one embodiment the rheology modifier is present in an amount of from 0.05 to 0.2% by weight of the composition. The rheology modifier may be present in an amount of from 0.1% to 0.15% by weight of the composition. The rheology modifier may be present in an amount of approximately 0.12% by weight of composition.

In one embodiment the composition comprises a high boiling point solvent. The solvent may be present in an amount of from 10% to 20% based on the binder resin weight.

The coating composition may comprise a biocide. The coating composition may comprise a fungicide. The coating composition may comprise a pigment dispersing agent.

In one embodiment the coating composition comprises a whitening agent. The whitening agent may comprise zinc oxide. The zinc oxide may be present in an amount of from 0.5% to 5.0% on total formulation weight. The zinc oxide may be present in an amount of from about 2.0% on total formulation weight.

In one embodiment the coating composition comprises a wax emulsion. The wax emulsion may be present in an amount of from 0.25% to 1.5% on total formulation weight. The wax formulation may be present in an amount of about 0.625% on total formulation weight.

In another embodiment the coating composition comprises an hydraulic binder. The binder may be present in an amount of from 1.0% to 5.0% on total formulation weight The binder may be present in an amount of about 2.0% on total formulation weight.

In one embodiment the composition comprises a silicone emulsion. The silicone emulsion may be present in an amount of from 1.0% to 10.0% on total formulation weight. The silicone emulsion may be present in an amount of about 5% on total formulation weight.

The coating composition may comprise a de-foaming agent.

In one embodiment the coating composition comprises a fibre reinforcing media. The fibres may be present in an amount of from 0.25% to 5.0% on total formulation weight. The fibres may be present in an amount of about 0.5% on total formulation weight.

The invention also provides a method of coating a surface comprising applying a coating composition of the invention. In one embodiment the coating composition is applied by a roller technique.

### DETAILED DESCRIPTION

The invention will be more clearly understood from the following description thereof given by way of example only.

### EXAMPLE 1

A rollable coating composition for in situ coating a wall is prepared from the following ingredients:

| | Component | % w/w |
|---|---|---|
| | Water | 21.65 |
| 1. | Laponite B | 0.12 |
| 2. | Cellosize H 15,000 ypz | 0.32 |
| 3. | Nipacide CFB | 0.22 |
| 4. | Nipacide DFF | 0.08 |
| 5. | Pigment Disperser A | 0.87 |
| 6. | Revacryl 248 | 6.5 |
| 7. | Omycarb 5ML | 69.29 |
| 8. | Tioxide TR92 | 0.87 |
| 9. | Rhodoline DF6681 | 0.08 |

1. This is a synthetic layered silicate. It imparts shear and sensitive rheology and improves stability and syneresis control—from Rockwood Additives Limited.
2. This is a medium weight cellulosic polymer thickening agent—from Dow Chemical Company.
3. This is a low toxicity biocide for microbiological protection against bacterial and fungal spoilage in the wet state. It is a water based liquid—from Clairant UK Limited.
4. This is a low toxicity biocide for microbiological protection against algal and fungal spoilage in the dry state. It is a glycol based solution—from Clairant UK Limited.
5. This is a solution of ammonium polyacrylate available from BASF.
6. This is a surfactant stabilised styrene acrylic ester copolymer dispersion.
7. This is calcium carbonate from OMYA of New Zealand with a particle size range of less than 25 microns.
8. This is a multipurpose rutile pigment/whitening agent from Huntsman Tioxide.
9. This is a high performance deafoamer from Rhodia.

To prepare the coating composition, water is first added to a mixing vessel followed by the thickening agents. The mixture is agitated for about 5 minutes after which the biocide is added to the mixture, followed by the fungicide. The mixture is again agitated for about 2 minutes. The pigment dispenser is then added and the vessel contents are agitated for a further minute. The polymeric binder is added and the mixture is agitated for about a further 5 minutes. The calcium carbonate and whitener pigment are then added and the vessel contents are mixed until there is a substantially uniform dispersion. Finally the defoaming agent is added and the vessel contents are mixed for a further two minutes.

The mixture thus formed is filled into containers of a suitable size such as 5, 10 or 20 litres and sealed with an airtight lid.

In use, the coating composition can be applied directly using a roller. The coating is applied by a roller to a thickness of about 1 to 2 mm without sagging.

The liquid may be applied directly to a wall. The liquid coating composition thus formed may then be applied to a plasterboard wall using a conventional roller. The surface is coated with an even and consistent film which on drying, provides a “white-out” surface.

It has been found that the coating achieves a very high quality surface finish to which gloss or matt paint may be applied directly without joint photographing or show-through of fasteners.

### EXAMPLE 2

Another rollable coating composition for in-situ coating a wall is prepared from the following ingredients:

| | Component | % w/w |
|---|---|---|
| | Water | 21.17 |
| 1 | Laponite B | 0.10 |
| 2 | Natrosol 250HBR | 0.36 |
| 3 | Acticide MBO | 0.22 |
| 4 | Acticide OTW8 | 0.08 |
| 5 | DispexA40/Decal 2041 | 0.87 |
| 6 | Revacryl 248 | 6.50 |
| 7 | Omyacarb 5ML | 69.72 |
| 8 | Tiona TC90 | 0.46 |
| 9 | Dispelair CF525 | 0.10 |
| | Texanol | 0.42 |

The composition is prepared as outlined in Example 1 above.

Natrosol 250HBR is a water soluble hydroxyethycellulose (from Hercules) and functionally equivalent to the Cellosize of Example 1. Acticide MBO (from Thor) is equivalent to Nipacide CFB. Acticide OTW8 (from Thor) is functionally equivalent to Nipacide DFF. DispexA40 (from Ciba) and Decal 2041 (from Devine Chemicals) are equivalent to Pigment Dispenser A. Tiona TC90 (from Millenium Chemicals) is equivalent to Tioxide TR 92. Dispelair CF525 (from Blackburn Chemicals) is equivalent to Rhodoline DF66812.

Texanol is a high boiling point solvent from Eastman. Its function is as a coalescent to prevent cracking. The amount of Texanol may be increased in the above formulation such that the Texanol is added in an amount of about 16% on resin weight. The Texanol may be present in an amount of 1.03 kg in a 100 kg batch.

White spirit may be used in combination with Texanol as a coalescing agent. The white spirit may be present in an amount of about 25% on resin weight. White spirit can be used as a replacement for Texanol where faster film formation with lower residual odour is required. Texanol and white spirit can be used together for film development properties.

### EXAMPLE 3

A coating composition for in-situ coating using a trowel is prepared from the following ingredients:

| Component | % w/w |
|---|---|
| Water | 21.11 |
| Laponite B | 0.10 |
| Natrosol 250HBR | 0.74 |
| Acticide MBO | 0.22 |
| Acticide OTW8 | 0.08 |
| DispexA40/Decal 2041 | 0.87 |
| Revacryl 248 | 6.44 |
| Omyacarb 5ML | 69.39 |
| Tiona TC90 | 0.47 |
| Dispelair CF525 | 0.08 |
| Texanol | 0.50 |

The difference between the roller applied product and trowel applied product is viscosity. The trowel formulation contains 105.6% more hydroxyethylcellulose which makes the formulation thicker (assists in reducing sag in thick films and gives better film build) and gives better controlled drying in thick films (due to good water retention).

Laponite RD may be used as an alternative to Laponite B in an exact weight for weight switch in the above formulations. Laponite RD may be preferred in view of superior anti-sedimentation properties.

The composition of the invention comprises a rheology modifier, especially a synthetic clay such as laponite and a thickener, especially a cellulose based thickener. We have found that this combination is important in achieving desired rheological properties. The combination of an acrylic-based binder and the calcium carbonate filler is also important in achieving the rollable composition of the invention. The thickener and rheology modifier combined with the selection of the filler provides the rheological properties of the roller and trowel applied products of the invention. The combination of hyroxyethylcellulose and Laponite gives excellent filler suspension and syneresis control. The gradual film build imported by the Laponite gives excellent flow and leveling. The selection of Omyacarb 5 as the filler with a fine particle size and low oil absorption gives a system with good flow and ease of application which is especially desirable for a DIY (do-it-yourself) product.

It will be appreciated that it may be possible to use a range of acrylic and/or vinylacetate binders in the composition of the invention. The binder is preferably an acrylic-based binder, especially a copolymer of styrene/butyl acrylate. It may also be acrylic comprising the comonomers of ethylhexylacrylate and/or methylmethacrylate and/or butylacrylate. It may also be possible to use a vinylacetate binder such as polyvinylacetate, vinylacetate/ethylene, vinylacetate/ethylene/acrylic acid ester, vinylacetate/ethylene/vinylchloride.

Zinc oxide may be utilised as a white pigment component in an amount of from 0.5% to 5%, preferably about 2.0% on total formulation weight. In addition to acting as a white pigment the zinc oxide would also impart a degree of mildew and fungi protection on the dry plaster film. The zinc oxide will also increase the opacity of the plaster film. Such zinc oxide may be AZO-ZZZ-111-American Zinc Sales Company or EP-AAA-427W-Eagle Pitcher Industries Inc XX-503-New Jersey Zinc Company.

The formulation may also comprise an hydraulic binder to improve the abrasion resistance of the dry plaster film. It is anticipated that such an hydraulic binder would improve flexural strength and adhesion. The hydraulic binder can be either a copolymer of vinyl acetate and ethylene or preferably a terpolymer of vinyl acetate/vinyl versatate/vinyl laurate. The hydraulic binder may be present in an amount of from 1.0% to 5.0%, preferably about 2.0% on total formulation weight. Such a binder may be Vinnapas RE 545Z vinyl acetate/ethylene redispersible powder from Wacker Chemie, Germany or (preferred) Vinnapas RI 538Z a vinyl acetate/vinyl versatate/vinyl laurate redispersible powder also from Wacker Chemie, Germany.

The formulation may comprise a wax emulsion to increase the water repellant properties of the plaster in the initial stages of drying. It is anticipated that such a wax emulsion will assist in preventing shrinkage cracks after the plaster has dried through.

One such wax emulsion is Basophob WDS, an aqueous paraffin wax dispersion as manufactured by BASF, Germany. The wax emulsion may be present in an amount of from 0.25% to 1.5%, preferably about 0.625% on total formulation weight.

The formulation may also comprise a silicone emulsion as a co-binder resin for use with the acrylic-based binder (in the examples above Revacryl 248) to provide a very hydrophobic surface after the plaster has dried through. Such a co-binder may be especially useful in situations where the plaster will not be over-coated with paint or wallpaper. One such silicone emulsion is Tegophobe 1000, a polymethyl phenyl silicone resin as manufactured by Tego Chemie Service GmbH. The silicone emulsion may be present in an amount of from 1.0% to 10.0%, preferably about 5.0% on total formulation weight.

Fibre reinforcing media may be used to improve the flexural strength of the formulation to assist in crack resistance and flexibility. The fibre may, for example be one of more of cellulose fibres available from Excel Industries Limited or polyester fibres Type PE1 (1 mm) available from F.H. Wrigley Ltd. UK or Dralon fibres (3.33 mm) available from Schwarzwaelder Textile Works GmbH. The fibres may be typically from 0.5 mm to 5.0 mm, preferably about 1 mm to 3.5 mm. They may be present in an amount of from 0.25% to 5.0%, preferably about 0.5% on total formulation weight.

It may be possible to substitute fillers/extenders for some of the calcium carbonate. Such fillers/extenders include barium sulphate, china clay (aluminium silicate), dolomite (calcium magnesium carbonate), talc (magnesium silicate) or blends thereof.

It will be appreciated that while the invention has been described as a coating for application to plasterboard panels the coating composition may be applied to other surfaces for example as a primer for a wallpaper, or tiling.

The invention is not limited to the embodiments hereinbefore described which may be varied in detail.

1-45. (canceled)

46. A coating composition for in-situ coating of a surface comprising calcium carbonate, an acrylic or vinylacetate-based binder, a thickening agent, and a rheology modifier, the weight ratio of the calcium carbonate to binder being from 5:1 to 15:1

47. The coating composition as claimed in claim 46 wherein the weight ratio of calcium carbonate to binder is from 7:1 to 14:1.

48. The coating composition as claimed in claim 46 wherein the weight ratio of the calcium carbonate to binder is approximately 10:1.

49. The coating composition as claimed in claim 46 wherein the calcium carbonate is present in an amount of from 65 to 80% by weight of the composition.

50. The coating composition as claimed in claim 49 wherein the calcium carbonate is present in an amount of approximately 70% by weight of the composition.

51. The coating composition as claimed in claim 46 wherein the binder is present in an amount of from 5 to 10% by weight of the composition.

52. The coating composition as claimed in claim 46 wherein the binder is present in an amount of approximately 6.5% by weight of the composition.

53. The coating composition as claimed in claim 46 wherein the binder is a styrene acrylic binder.

54. The coating composition as claimed in claim 46 wherein the binder is an acrylic binder.

55. The coating composition as claimed in claim 46 wherein the thickening agent comprises a cellulose thickener.

56. The coating composition as claimed in claim 55 wherein the cellulose thickener is present in any amount of from 0.1% to 0.5% by weight of the composition.

57. The coating composition as claimed in claim 55 wherein the cellulose thickener is present in an amount of from 0.2% to 0.4% by weight of the composition.

58. The coating composition as claimed in claim 55 wherein the cellulose thickener is present in an amount of from 0.25% to 0.35% by weight of the composition.

59. The coating composition as claimed in claim 46 wherein the rheology modifier comprises a synthetic clay.

60. The coating composition as claimed in claim 46 wherein the rheology modifier comprises a synthetic silicate.

61. The coating composition as claimed in claim 46 wherein the rheology modifier is laponite.

62. The coating composition as claimed in claim 46 wherein the rheology modifier is present in an amount of from 0.05 to 0.2% by weight of the composition.

63. The coating composition as claimed in claim 46 wherein the rheology modifier is present in an amount of from 0.1% to 0.15% by weight of the composition.

64. The coating composition as claimed in claim 46 wherein the rheology modifier is present in an amount of approximately 0.12% by weight of composition.

65. The coating composition as claimed in claim 46 comprising a high boiling point solvent.

66. The coating composition as claimed in claim 65 wherein the solvent is present in an amount of from 10% to 20% based on the binder resin weight.

67. The coating composition as claimed in claim 46 comprising a biocide.

68. The coating composition as claimed in claim 46 comprising a fungicide.

69. The coating composition as claimed in claim 46 comprising a pigment dispersing agent.

70. The coating composition as claimed in claim 46 comprising a whitening agent.

71. The coating composition as claimed in claim 67 wherein the whitening agent comprises zinc oxide.

72. The coating composition as claimed in claim 71 wherein the zinc oxide is present in an amount of from 0.5% to 5.0% on total formulation weight.

73. The coating composition as claimed in claim 71 wherein the zinc oxide is present in an amount of from about 2.0% on total formulation weight.

74. The coating composition as claimed in claim 46 comprising a wax emulsion.

75. The coating composition as claimed in claim 74 wherein the wax emulsion is present in an amount of from 0.25% to 1.5% on total formulation weight.

76. The coating composition as claimed in claim 73 wherein the wax formulation is present in an amount of about 0.625% on total formulation weight.

77. The coating composition as claimed in claim 46 comprising an hydraulic binder.

78. The coating composition as claimed in claim 77 wherein the binder is present in an amount of from 1.0% to 5.0% on total formulation weight.

79. The coating composition as claimed in claim 77 wherein the binder is present in an amount of about 2.0% on total formulation weight.

80. The coating composition as claimed claim 46 comprising a silicone emulsion.

81. The coating composition as claimed in claim 80 wherein the silicone emulsion is present in an amount of from 1.0% to 10.0% on total formulation weight.

82. The coating composition as claimed in claim 80 wherein the silicone emulsion is present in an amount of about 5% on total formulation weight.

83. The coating composition as claimed in claim 46 comprising a de-foaming agent.

84. The coating composition as claimed in claim 46 comprising fibre reinforcing media.

85. The coating composition as claimed in claim 84 wherein the fibres are present in an amount of from 0.25% to 5.0% on total formulation weight.

86. The coating composition as claimed in claim 84 wherein the fibres are present in an amount of about 0.5% on total formulation weight.

87. The method of coating a surface comprising applying a coating composition as claimed in claim 46.

88. The method as claimed in claim 87 wherein the coating composition is applied by a roller technique.
